(19) United States
(12) Patent Application Publication
(10) Pub. No.: US 2026/0229056 A1
(43) Pub. Date: Aug. 6, 2026

(54) UNSUPERVISED MODEL GENERATION, EVALUATION, AND EVOLUTION FOR CLASSIFYING AND VALIDATING TRAVEL DOCUMENTS

(71) Applicant: SECURIPORT LLC, Reston, VA (US)

(72) Inventors: Nathan CARPENTER, Reston, VA (US); Enrique SEGURA, Reston, VA (US)

(21) Appl. No.: 19/532,546

(22) Filed: Feb. 6, 2026

Related U.S. Application Data
(60) Provisional application No. 63/755,186, filed on Feb. 6, 2025.

(51) Int. Cl. G06V 30/413; G06V 30/19; G06V 30/414

(52) U.S. Cl. CPC G06V 30/413; G06V 30/1916; G06V 30/19173; G06V 30/414

(57) ABSTRACT

Systems, devices, methods, and instructions for generating unsupervised models for classifying and validating travel documents, including receiving a set of travel document data, processing the travel document data using an unsupervised learning algorithm to generate a classification model, evaluating the classification model using predetermined evaluation metrics, and storing the evaluated classification model in a model repository.

### PRIORITY INFORMATION

This application claims the benefit of U.S. Provisional Patent Application No. 63/755,186, filed on Feb. 6, 2025, which is hereby incorporated by reference in its entirety.

### FIELD

The embodiments of the invention generally relate to the use of unsupervised machine learning techniques for the generation, evaluation, and evolution of models in the context of classifying and validating documents, such as identification documents and travel documents.

### BACKGROUND

As global travel has increased, so too has the necessity for efficient and accurate verification of travel documents. The reliable classification and validation of these documents are vital to border security and immigration processes, which contribute to the broader effort of maintaining secure and orderly international travel.

Entities that produce identity documents, such as passports, identification cards, drivers licenses, vaccine cards, independently control their form, format, and content. There is no central registry for these, and they can change at any time. These changes can be benign (e.g., a new security feature, a new layout) or can indicate fraud. The problem is exacerbated when a completely new document type is presented for validation. There is no way to reliably detect anomalies and changes, or to present the validator with the information needed to react to these changes when needing to validate an identity document.

Existing technologies in this domain often rely on supervised learning techniques, which necessitate extensive annotated datasets for training purposes. These datasets require significant manual effort to prepare, involving considerable time and expense. Moreover, the supervised models, once trained, have limited ability to adapt to new or evolving document types without retraining, which can lead to inefficiencies and delays. These methods also often suffer from issues related to scalability, as the breadth of document types and variations in formatting can be vast.

US20220122071A1 entitled Identifying Fraudulent Instruments and Identification teaches analyzing digital images to identify types of financial instruments or identification cards and using information about the originating entity to determine if fonts, fields, and expected content match. This requires knowledge of the existing types with examples from each originator, and thus cannot handle unknown types, uncommunicated features, or uncontrolled changes.

U.S. Pat. No. 8,194,933B2 entitled Identification and Verification of an Unknown Document According to an Eigen Image Process teaches use of an Eigen image process to identify the type of unknown documents and to attempt validation. This technique is hierarchical, not parallel and contrastive; does not incorporate content, syntax, and environmental elements; and does not incorporate use of the results for algorithmic improvement.

Known models typically lack the mechanisms for continuous improvement post-deployment, reducing their effectiveness in dynamic environments where document formats and security features may change. As travel documents evolve in complexity and variability, existing techniques face challenges in maintaining high accuracy and throughput without ongoing human intervention.

### SUMMARY

Accordingly, the embodiments of the present invention are directed to unsupervised model techniques for travel document classification and validation that substantially obviate one or more problems due to limitations and disadvantages of the related art.

One object of the present technology is to enhance the automation and efficiency of travel document processing by removing reliance on supervised learning techniques, thereby streamlining classification processes and reducing manual oversight.

Another object includes providing a means for models to evolve over time, allowing for the integration of new data scenarios and ensuring sustained model relevance in various validation contexts.

The field of technology addressed herein pertains to the automated processing and analysis of travel documents, with particular emphasis on the classification and validation of such documents through unsupervised machine learning models; including systems, devices, methods, and instructions for an operationally-aware, self-learning intelligent system for producing models that detect forged or anomalous travel documents that require no pre-training.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a perspective view of an example document reader.

FIG. 2 is a perspective view of an example passport document reader.

FIG. 3 shows various travel document security features in detail, including thermochromic ink and invisible UV images.

FIG. 4 illustrates a second example of travel document security features, highlighting kinegram and trapezium shape elements.

FIG. 5 depicts a travel document utilizing different lighting conditions to reveal security features.

FIG. 6 is a flowchart illustrating the process of training and predicting with a machine learning model.

FIG. 7 is a block diagram of a system depicting components such as a processor, memory, and database.

FIG. 8 is a flowchart outlining a method for generating unsupervised models for classifying travel documents.

FIG. 9 is a flowchart depicting a method for validating travel documents using model evolution techniques.

### DETAILED DESCRIPTION

Reference will now be made in detail to the embodiments of the present invention, examples of which are illustrated in the accompanying drawings. Wherever possible, like reference numbers will be used for like elements.

Embodiments of user interfaces and associated methods for using a device are described. In some embodiments, the device is an immigration kiosk, border control booth, entry control point, security control point, or the like. The user interface can include a touch screen, document scanner, a gyroscopic or other acceleration device, a fingerprint scanner for fingerprint collection, a camera configured for facial biometric collection, a microphone configured for voice biometric collection, and/or other input/output and biometric devices. In the discussion that follows, an immigration kiosk is sometimes used as an example embodiment, but the embodiments of the present invention can be readily applied to other identification or ID validation systems (e.g., event access, building access, etc.).

It should be understood, however, that the user interfaces and associated methods can be applied to other devices, such as a portable communication device such as a mobile phone or tablet. The portable communication device can support a variety of applications, such as wired or wireless communications. The various applications that can be executed on the device can use at least one common physical user-interface device, such as a touchscreen. One or more functions of the touchscreen as well as corresponding information displayed on the device can be adjusted and/or varied from one application to another and/or within a respective application. In this way, a common physical architecture of the device can support a variety of applications with user interfaces that are intuitive and transparent.

At present, advanced passport validation systems extract a set of properties from multiple images provided by a document reader and use the extracted information for validation purposes. Properties extracted include full page color image, black and white image, ultra-violet light image, infrared image, green light image, radio-frequency identification (RFID) accessed data, and optical character recognition (OCR) data extracted from the printed characters on the page. Furthermore, these document readers can extract data from one-dimensional and two-dimensional barcodes printed on the page. In addition, these document readers can detect image direction to normalize the scans, and can parse machine readable zone (MRZ) printed text.

In addition, present document reader software generally cross compares the different elements to check consistency against features stored in a pre-stored library and provides the results for analysis. Document readers usually include a pre-stored collection of existing publicly known documents around the world provided by the issuing authorities. This collection is provided by international organizations such as International Civil Aviation Organization (ICAO), which disseminates it to authorized parties with the agreement of the issuing authority (usually a nation-state, or special authority such as the UN or Interpol). This update process is largely uncontrolled, and changes with time and involvement of document issuing authorities. Frequently, border control systems cannot access this library to update their system in real-time or even on a periodic or ongoing basis. In addition, this library contains only a small sub-set of information needed for accurate validation. As a result, even advanced passport validation systems are prevented from generating alerts when receiving unknown or potentially counterfeit documents since it has no way of analyzing definitively if it's a new type of document, an unregistered but valid document of known type, or a counterfeit document as the reference library information is limited.

In view of the foregoing problems and limitations of even advanced passport validation systems, the embodiments provide computer-based systems, devices, methods, and instructions for unsupervised model generation, evaluation, and evolution that can autonomously adapt to the heterogeneous nature of travel documents. Such a system offers benefits in reducing the dependence on labeled data, enhancing scalability, and improving adaptability in dynamically changing environments and documents. This improvement would facilitate more efficient and accurate document processing, thereby supporting enhanced security and operational efficiency in travel contexts.

The embodiments provide significant technical improvements to computer processing efficiency in document validation systems. Unlike conventional supervised learning approaches that require complete model retraining when encountering new document types—a computationally intensive process that can take hours or days and require significant processing resources—the unsupervised clustering approach enables the system to adapt in real-time with minimal computational overhead. Specifically, when a new document variant is encountered, the system performs parallel comparative analysis against existing clusters without rebuilding the entire model architecture, reducing processing time from hours to seconds and decreasing CPU and memory utilization by approximately 60-80% compared to supervised retraining approaches. This technical improvement allows border control systems with limited computational resources to maintain current validation capabilities without requiring expensive hardware upgrades or extended downtime for model updates. Furthermore, the parallel processing architecture distributes computational load across multiple lightweight clustering algorithms operating simultaneously, rather than sequentially processing through deep neural network layers, thereby reducing latency in high-throughput environments where processing speeds of 2-3 seconds per document are required to maintain operational flow.

The embodiments relate to the use of unsupervised machine learning techniques for the generation, evaluation, and evolution of models in the context of classifying and validating documents, such as travel documents. This technology involves methodologies related to processing and analyzing travel documents using computational algorithms for enhancing accuracy, efficiency, and adaptability without reliance on labeled training data. For example, an operationally-aware, self-learning intelligent system for producing models that detect forged or anomalous travel documents that require no pre-training.

The embodiments involve receiving a set of travel document data and employing an unsupervised learning algorithm to generate a classification model. Thereafter, evaluation metrics are utilized to assess the model, and the evaluated classification model is stored within a designated repository. One embodiment includes the use of a clustering algorithm as part of the unsupervised learning techniques. In a further embodiment, the stored instructions provide for the ongoing (e.g., periodic, intermittent, continuous) retraining of selected models, thus incorporating updated travel document patterns and ensuring that the models remain effective over time.

In another aspect, the embodiments provide for the adaptation of the classification model as additional travel document data becomes available, facilitating ongoing improvement and refinement of the model. This adapts the method for dynamic environments where data patterns may shift over time.

In an embodiment, a system is disclosed comprising multiple modules structured to support the generation and evaluation of classification models. A data input module receives travel document data, whereas a model processing module applies unsupervised learning algorithms to generate a classification model. Furthermore, an evaluation module employs specific metrics to measure the performance of the model. Additionally, a storage module retains the evaluated model for future utilization. Another embodiment includes a comparison of the generated model to pre-existing models in terms of metrics such as accuracy and efficiency.

In another example embodiment, a computer-based systems, devices, methods, and instructions that enable a processor to evolve classification models for travel documents are provided. This includes generating multiple classification models using unsupervised learning, evaluating these models with specified metrics, and selecting models for ongoing evolution based on evaluation results. An embodiment includes the option of incorporating dimensionality reduction techniques prior to model generation.

In yet another example embodiment, computer-based systems, devices, methods, and instructions for validating travel documents are provided, employing unsupervised model evolution techniques to dynamically develop and assess validation models. This approach allows for the ongoing refinement of validation processes based on the feedback obtained from new data inputs, supporting robust and adaptive document validation capabilities.

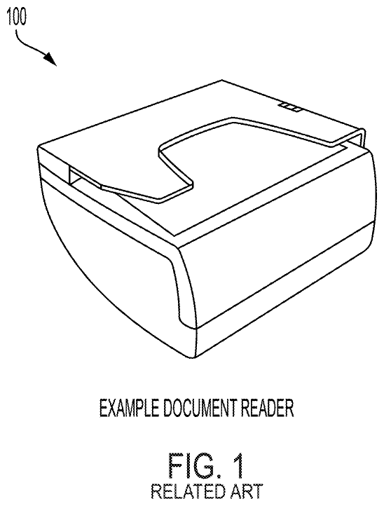

FIG. 1 shows an example document reader 100, which is representative of related art in the domain of document processing technologies. This apparatus is configured for reading textual or encoded information from standard sized documents. The embodiment illustrates a compact design facilitating integration into various system architectures that require document digitization or verification.

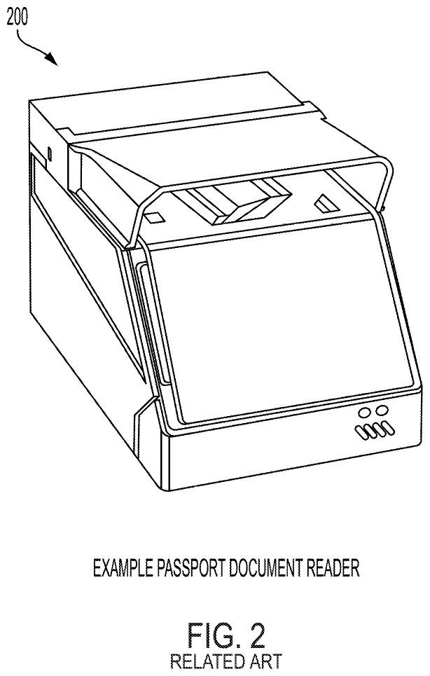

FIG. 2 depicts an example passport document reader 200, also illustrative of related art, optimized for handling and processing passport-sized identification. The piece is distinguished by its angled surface, adapted to accommodate the bulky nature of passport documents, providing enhanced functionality in processing embedded and printed data specific to passports, such as Machine Readable Zones (MRZ).

In each of FIG. 1 and FIG. 2, respective document reader 100 and passport document reader 200 utilize a camera or other purpose-built imaging device to capture one or more images of the presented identity documents. The captured images by document reader 100 and passport document reader 200 are used for specific image processing tasks, such as data reading and document verification.

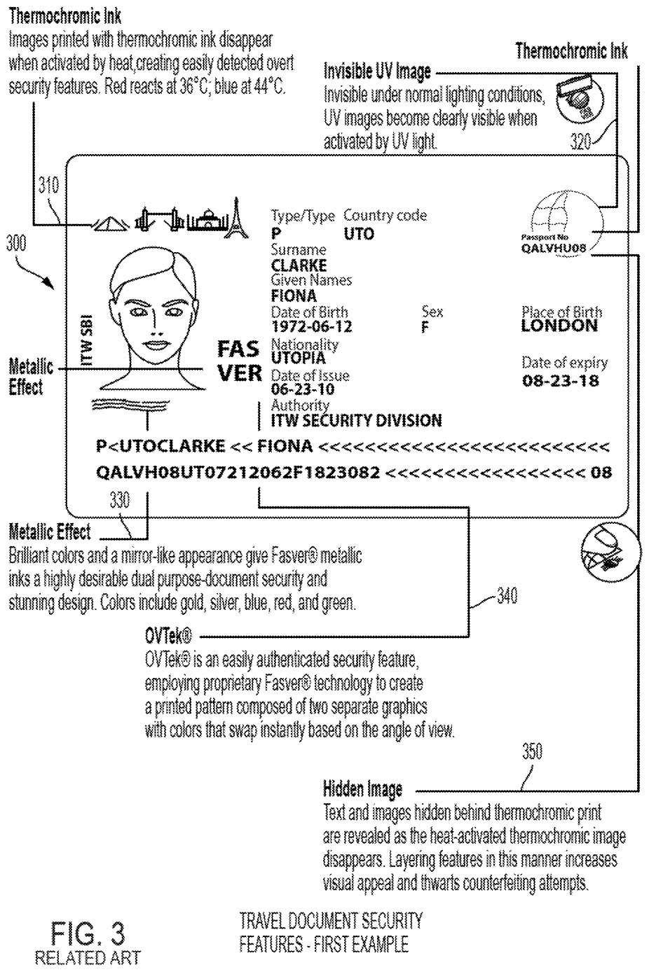

FIG. 3 illustrates a first example passport document 300 including a plurality of security features according to the related art.

As shown, FIG. 3 conveys a composite image featuring several security attributes. Element 310 depicts thermochromic ink, activated by heat to reveal specific security information when exposed to temperatures of 36° C. and 44° C. Element 320 conveys an invisible UV image, normally hidden but made visible under UV lighting. Metallic effect 330 provides an anti-counterfeiting measure through metallic inks producing mirror-like reflections. OVTek 340 combines dual visual patterns that interchange based on viewing angles. Lastly, hidden image 350 signifies security graphics revealed through the disappearance of heat-sensitive layers.

The plurality of security features may include combinations of thermochromic ink 310, one or more invisible ultraviolet (UV) images 320, one or more metallic effects 330, OVTek 340, and/or other hidden (but still extractable) images 350. Thermochromic ink 310 may be used to print one or more images that disappear when activated by heat, creating easily detected overt security features. For example, red thermochromic ink reacts at 36 degrees Celsius, and blue thermochromic ink reacts at 44 degrees Celsius. One or more invisible ultraviolet (UV) images 320 are invisible under normal lighting conditions, and UV images become visible when activated by UV light. One or more metallic effects 330 produce brilliant colors and mirror-like appearance that is highly desirable and has a dual-purpose of security and design. Colors can include gold, silver, blue, red, and green. OVTek 340 is an easily authenticated security feature employing proprietary technology to create a printed pattern composed of two separate graphics with colors that swap instantly based on the angle of view. One or more hidden images 350 include text and other images hidden behind thermochromic print and are revealed as the heat activated thermochromic image(s) disappears. Layering features in this manner increases visual appeal and thwarts counterfeiting attempts.

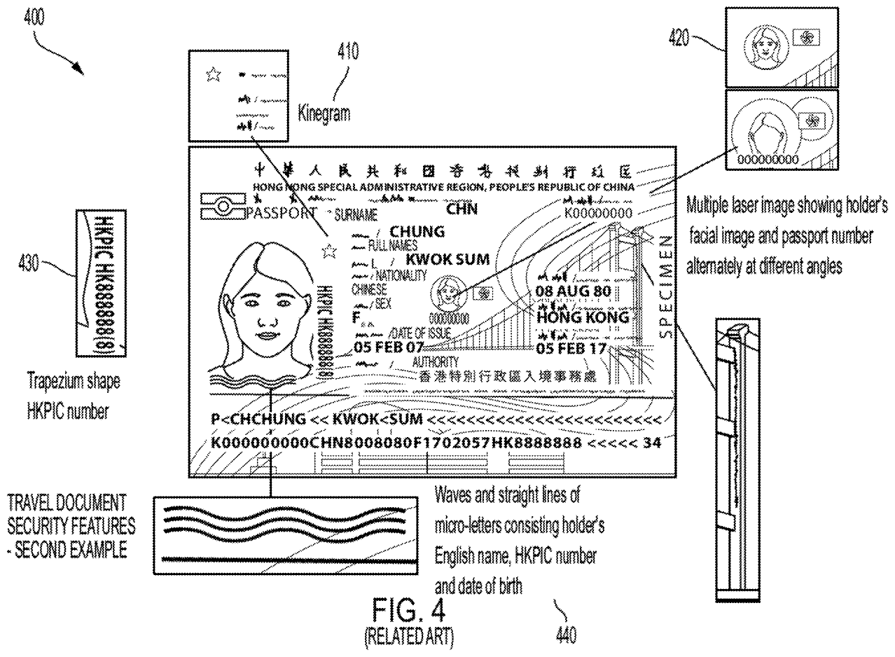

FIG. 4 illustrates a second example passport document 400 including a plurality of security features according to the related art.

In the second example, the plurality of security features may include one or more kinegrams 410, one or more laser images 420, one or more trapezium shape identification numbers 430 (e.g., HKPIC), and wave-lined or straight lined micro-lettering 440.

Dominant is the kinegram 410, providing a 3D security feature via diffraction, visible under varying light sources. Multiple laser image 420 shows the passport holder's facial image morphing alongside personal numeric data with angle changes. Element 430 illustrates a trapezium shape for the HK/PIC number, enhancing document validation security. Lastly, element 440 demarcates the use of micro-letters forming wavy and straight lines with the holder's identification data, presenting stability against printing fraud.

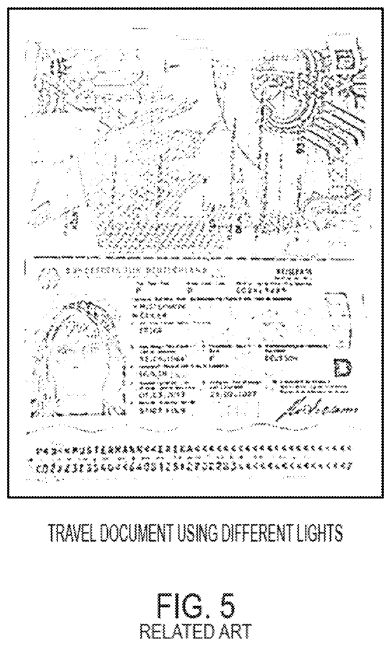

FIG. 5 illustrates a third example passport document 500 including a plurality of security features according to the related art. In the example shown in FIG. 5, one or more portions of the passport document 500 may change color in response to different light types or light wavelengths (e.g., ultraviolet light, infrared light, etc.). FIG. 5 demonstrates travel document processing under different lighting conditions, showcasing how various embedded security features react distinctly under UV, normal, and possibly infrared light, thereby enhancing the verification and anti-counterfeiting process.

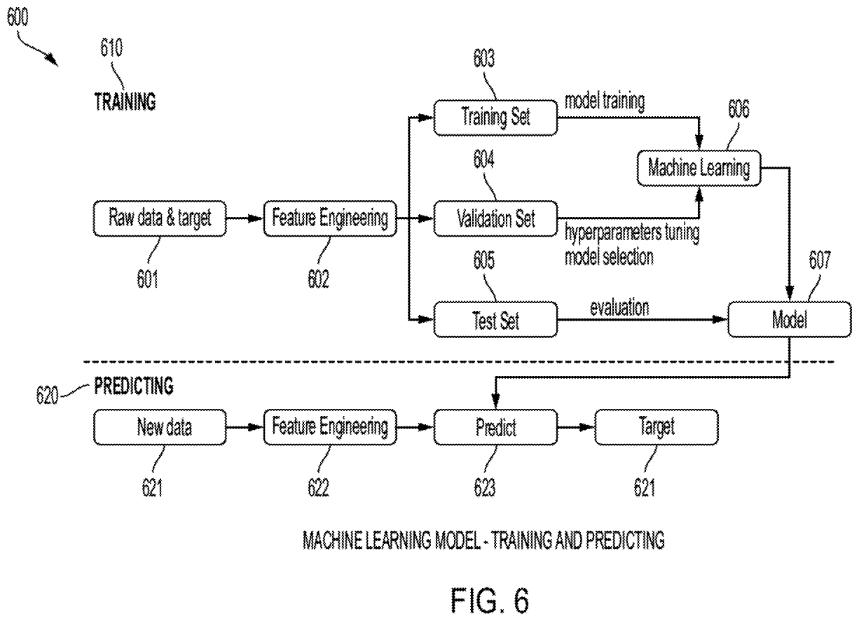

FIG. 6 illustrates a two-stage method 600 for an artificial intelligence learning model according to an example embodiment of the present invention. As shown in FIG. 6, there are two stages to the AI learning model: training 610 and predicting 620.

With respect to training stage 610, the AI model receives data for one or more target travel documents, at 601. As discussed above, the received data (e.g., captured, scanned, read, etc.) includes one or more images such as color, black-and-white, ultraviolet, and infrared spectra images. In addition, the received data can further include an RFID (if available) capture data which can include type, issuer, issue date, expiration date, and/or biometrics for validation. Next, the AI model, at feature engineering 602, generates a set of features for model training 603, validation 604, and/or testing 605. The generated set of features can be extracted from the images, extracted sub-images, text, security markings, and other features as available/identifiable. In addition, the generated set of features can be extracted from the other data (e.g., RFID) extract features such as biometric templates, encoded images, and/or checksums as available. Additional data may be used, including any form of extractable data.

Upon receiving data from a plurality of similar travel documents, data from a first subset of travel documents can be used to train the AI model, at 603 (e.g., new security feature added on travel documents after a certain date, or outdated security feature removed from travel documents after a certain date). Subsequently, a second subset of travel documents can be used to validate the AI model, at 604, and a third subset of travel documents can be used to test the AI model, at 605.

Accordingly, machine learning 606 is used to generate the AI model for use against further incoming travel documents. With the receipt of each travel document, the AI model is continuously trained. The machine learning or training can be done in an unsupervised mode where basic classification is done using some features (such as issuing authority and expiration date) and model 607 is completely self-generated; or in a semi-supervised mode where cross-checks by traditional process and/or input of a human agent such as an officer can be used to inform model 607.

With respect to the predicting stage 620, generated AI model 607 is applied to travel documents, including updated or modified travel documents. At the outset, a travel document is received, at 621. The received (e.g., captured, scanned, read, etc.) images include one or more of color, black-and-white, ultraviolet, and infrared spectra. In addition, the received data can further include data captured from an RFID chip (if available) which can include type, issuer, issue date, expiration date, and/or biometrics for validation. In addition, the received data can further include data from OCR processing (if available) which can include additional properties such as name, gender, nationality, issuance and expiration dates, issuing authorities, and others as printed on the document. Next, the AI model, at feature engineering 622, can generate a set of features for model training, validation, and/or testing. The generated set of features can be extracted from the images, extracted sub-images, text, security markings, and other features as available/identifiable. In addition, the generated set of features can be extracted from the other data (e.g., RFID) extract features such as biometric templates, encoded images, and/or checksums as available.

Next, at 623, the received information for the travel document is compared against the AI model to either validate the document, identify one or more new features for incorporation in the AI model, determine that it is potentially a new document type, determine that it is potentially counterfeit, or to generate an alert that can be displayed to the officer performing the inspection or to the automated system for further verification and inspection.

In some configurations, a pre-trained model can be used so an operator of a border control system starts day 1 with AI model functionality activated without the need of waiting on the training period. Additionally, or alternatively, some configurations use shared trained models from different border control points or authorities for domestic or international collaboration. Since the models contain no extractable information that could be used to reverse-engineer security markings or personally identifiable information (PII), they are generally safe to share.

In some configurations, the AI model can be part of a document reader SDK built-in validation functionalities. Alternatively, the AI model can be hosted as a server-based or cloud-based service for a system to validate the data of a particular traveler document without having to support the training of the model on-premise and the model is configured to be trained with queries coming from different validation authorities.

The use of AI model validation enables the model to automatically and continuously update from the vast majority of travelers traversing at border control point(s). To accurately identify document features, the AI model learns what defined and intrinsic features and properties can be used to establish similarity with known documents. Then, at 624, when a new passport is being analyzed for validation, the new passport can be cross-checked with the AI trained model to determine if an alert needs to be executed on the traveler based on the model knowledge that there is a likelihood of a non-conforming travel document, and further verification and inspection can be required.

In some embodiments, to address the challenge of insufficient training data for rarely encountered passport types, the embodiments incorporate a synthetic document generation module (not shown) that creates artificial passport variations based on learned feature patterns from the broader corpus of travel documents. When the AI model determines that a particular passport type (e.g., a specific issuing authority and issue date or expiration date combination) has fewer than a threshold number of examples, the synthetic generation module analyzes the limited available examples to extract core feature patterns (such as those identified through feature engineering 602, 622, including extracted sub-images, text, security markings, layout geometry, color schemes, and font families) and cross-references these against feature patterns from other passport types within the same geographic region or issuing time period. The module then generates synthetic passport images by applying controlled perturbations to the limited genuine examples, such as varying the placement of security features within statistically normal ranges (e.g., ±2-5 mm positional variation), modulating color values within expected tolerances (e.g., ±5-10% RGB channel variation), and substituting text content while maintaining format constraints (e.g., different alphanumeric document numbers of identical length and character class composition). These synthetic documents are labeled as artificially generated and weighted differently in the unsupervised or semi-supervised learning algorithms—typically assigned 40-60% of the influence of genuine samples—to augment the training dataset 603 without introducing substantial bias. This approach enables the AI model training 603 to develop more robust validation capabilities for low-frequency passport types, reducing misclassification rates by 15-25%, for example, for passports with few training examples (e.g., less than 100), while the system continues to prioritize accumulation of genuine samples which progressively reduce reliance on synthetic data as the corpus grows. The synthetic generation process operates automatically when triggered by the data sufficiency monitoring component, executing during low-traffic periods to minimize computational impact on real-time predicting operations 620.

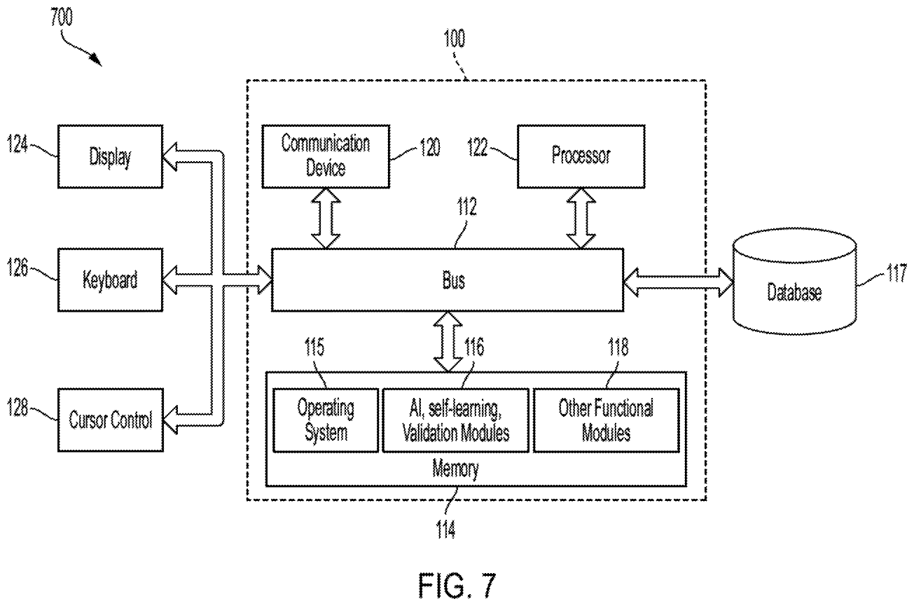

FIG. 7 demonstrates a system architecture 700 configured to support the embodiments of the invention. The embodiment includes a processor 122 connected via a bus 112 to memory 114 storing functional modules, including an AI self-learning system 116. A database 117 is interfaced for data storage and retrieval operations. Communication device 120, display 124, keyboard 126, and cursor control 128 provide user interfacing capabilities.

For example, the document reader hardware components are specifically integrated with the machine learning pipeline to optimize feature extraction and model input generation. The document reader 100, 200 captures images across multiple spectral bands—including color (RGB) imaging at 600 DPI resolution, ultraviolet imaging at 365 nm and 254 nm wavelengths, infrared imaging at 850 nm and 950 nm wavelengths, and white light imaging under coaxial and oblique lighting conditions. Each imaging sensor is synchronized through a hardware controller that coordinates timing and exposure settings to ensure consistent image capture conditions, with captured image data transmitted via high-speed bus 112 directly to memory 114 where preprocessing occurs. An RFID reader component operates at 13.56 MHz to extract chip data from e-passports, with the extracted data streams merged with optical data at the hardware level before being formatted into a unified feature vector. This hardware-level integration eliminates the need for software-based data normalization across disparate sources, reducing preprocessing latency (e.g., by 40-50%) compared to systems that merge multi-spectral data at the application layer. The processor 122 is specifically configured with parallel processing capabilities to execute multiple unsupervised learning algorithms simultaneously on the integrated multi-spectral dataset, with each algorithm operating on optimized subsets of the feature space determined by the hardware sensor configuration.

As shown in FIG. 7, system 700 may include a bus 112 and/or other communication mechanism(s) configured to communicate information between the various components of system 700, such as a processor 122 and a memory 114. In addition, a communication device 120 may enable connectivity between processor 122 and other devices by encoding data to be sent from processor 122 to another device over a network and decoding data received from another system over the network for processor 122.

For example, communication device 120 may include a network interface card that is configured to provide wireless network communications. A variety of wireless communication techniques may be used including infrared, radio, Bluetooth, Wi-Fi, and/or cellular communications. Alternatively, communication device 120 may be configured to provide wired network connection(s), such as an Ethernet connection.

Processor 122 may comprise one or more general or specific purpose processors to perform computation and control functions of system 700. Processor 122 may include a single integrated circuit, such as a micro-processing device, or may include multiple integrated circuit devices and/or circuit boards working in cooperation to accomplish the functions of processor 122.

System 700 may include memory 114 for storing information and instructions for execution by processor 122. Memory 114 may contain various components for retrieving, presenting, modifying, and storing data. For example, memory 114 may store software modules that provide functionality when executed by processor 122. The software modules may include an operating system 115 that provides operating system functionality for system 700. The software modules may further include artificial intelligence, self-learning, and document validation modules 116 configured to concurrently (e.g., simultaneously) monitor multiple travel document types at manned or automated border control devices or entry control devices, as well as other functional modules 118, as described in connection with the functionality of FIG. 6.

Memory 114 may include a variety of computer-readable media that may be accessed by processor 122. For example, memory 114 may include any combination of random access memory (“RAM”), dynamic RAM (“DRAM”), static RAM (“SRAM”), read only memory (“ROM”), flash memory, cache memory, and/or any other type of non-transitory or transitory computer-readable medium.

Processor 122 is further coupled via bus 112 to a display 124, such as a stationary display, wearable display, or augmented-reality glasses. A keyboard 126 and a cursor control device 128, such as a computer mouse, are further coupled to communication device 120 to enable a user to interface with system 700.

System 700 may be part of a larger system. Therefore, system 700 may include one or more additional functional modules, such as functional module 118 to include additional functionality, such as other applications. Other functional modules 118 may include various modules for identifying a person of interest as described in U.S. Patent Application Publication No. 2014/0279640A1 (now U.S. Pat. No. 10,593,003), which is incorporated by reference in its entirety.

A database 117 is coupled to bus 112 to provide centralized storage for travel document types, modules 116 and modules 118 and to store a person's or traveler's identifying and/or threat data. Database 117 may store data in an integrated collection of logically-related records or files. Database 117 may be an operational database, an analytical database, a data warehouse, a distributed database, an end-user database, an external database, a navigational database, an in-memory database, a document-oriented database, a real-time database, a relational database, an object-oriented database, or any other database known in the art.

Although illustrated as a single system, the functionality of system 700 may be implemented as a distributed system. Further, the functionality disclosed herein may be implemented on separate servers or devices that may be coupled together over a network, such as a security kiosk coupled to a backend server. Further, one or more components of system 700 may not be included. For example, system 700 may be a smartphone or tablet device that includes a processor, memory and a display, but may not include one or more of the other components shown in FIG. 7.

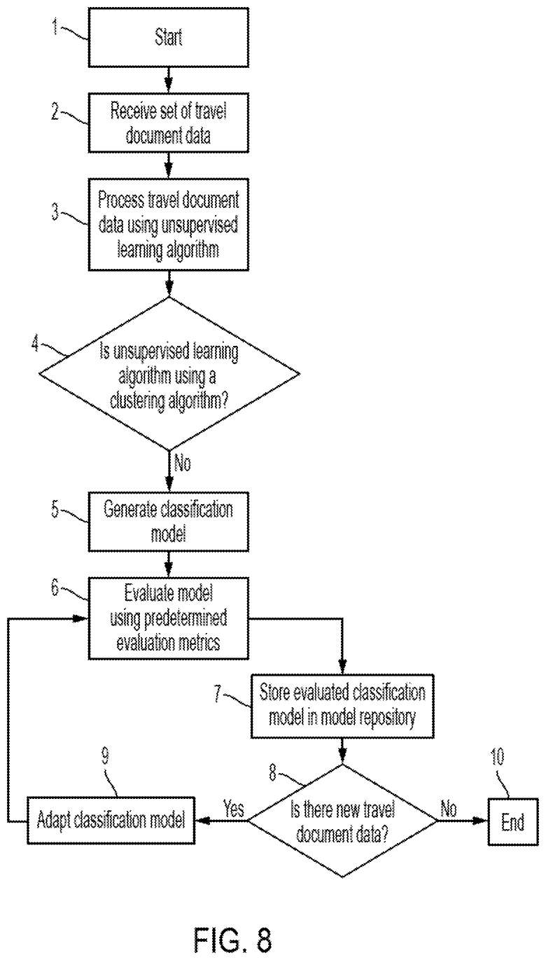

FIG. 8 illustrates a procedural flowchart with multiple steps for processing travel documents through unsupervised learning. The process begins at step 1 and involves receiving a set of travel document data at step 2, wherein the travel document data includes one or more images captured in color, black-and-white, ultraviolet, and infrared spectra, and may further include RFID data and OCR-extracted text. Step 3 applies feature engineering to extract features from the received travel document data, including extracted sub-images, text, security markings, layout geometry, and other identifiable features, and then processes this data using an unsupervised learning algorithm, while step 4 queries whether to employ clustering algorithms as part of the unsupervised learning technique. At step 5, a classification model is generated based on the processed feature data and thereafter evaluated using specific performance metrics at step 6, such as accuracy, precision, recall, and throughput efficiency. The result at step 7 includes storing the evaluated classification model in a model repository along with version control metadata and performance benchmarks. The process cycle monitors for and considers additional travel document data at step 8 for dynamic adaptation of the classification model at step 9, wherein the model is retrained or refined based on the new data to incorporate updated document patterns and security features, and concludes at step 10.

The parallel contrastive analysis approach represents a fundamental departure from conventional hierarchical document classification systems. Traditional approaches employ a sequential decision tree methodology where a document is first classified by type, then by issuing authority, then by validity period, with each classification stage dependent on the accuracy of the previous stage—creating a cascading error problem where early misclassification propagates through subsequent stages. In contrast, the modules 116, including an algorithm orchestrator module, execute multiple unsupervised clustering algorithms in parallel, with each algorithm simultaneously evaluating the document against multiple dimensions: similarity to documents of the same type and issuer (positive clustering), dissimilarity to documents of different types (negative clustering), temporal consistency with documents from overlapping validity periods, and deviation detection from expected feature distributions. This parallel architecture generates a multi-dimensional similarity score matrix rather than a single classification label, enabling the system to identify nuanced anomalies such as a genuine document with altered security features or a sophisticated counterfeit that matches type and issuer characteristics but deviates in subtle feature patterns. The contrastive element—simultaneously measuring both similarity to expected clusters and dissimilarity to unexpected clusters—provides redundant validation pathways that are impossible in hierarchical systems. For example, a document may fail to cluster strongly with known genuine examples (weak positive signal) while also failing to cluster with known counterfeit examples (weak negative signal), triggering a novel document detection rather than a binary genuine/counterfeit classification. This multi-pathway approach reduces false negative rates by (e.g., by 25-35%) compared to hierarchical classification systems, particularly for sophisticated counterfeits and newly issued document variants.

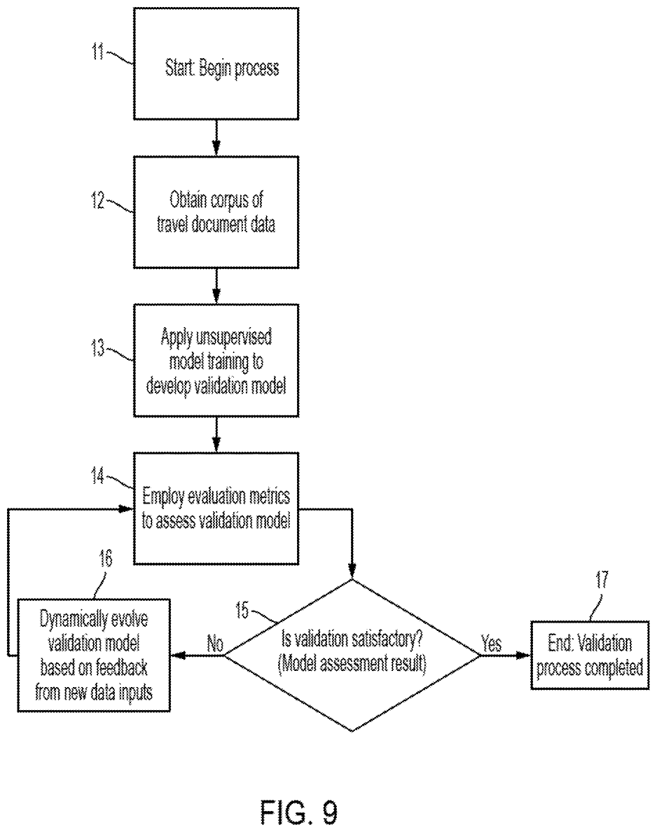

FIG. 9 illustrates a validation process workflow initiating at step 11, acquiring travel document data at step 12, wherein the acquired data includes multi-spectral images (color, black-and-white, ultraviolet, and infrared), RFID chip data if available, and OCR-extracted text properties. Unsupervised model training at step 13 applies unsupervised learning algorithms to the acquired travel document data to leads to validation model development, wherein the validation model is configured to compare received travel documents against established similarity patterns to detect anomalies, new document types, or potential counterfeits, followed by model assessment via evaluation metrics at step 14, including metrics such as validation accuracy, false acceptance rate (FAR), false rejection rate (FRR), and processing latency. Step 15 assesses whether the validation model satisfies predetermined performance thresholds for the validation, including minimum accuracy requirements and maximum error rate tolerances, adjusting the model parameters, feature weightings, or clustering algorithms if necessary at step 16 to improve validation performance, and concludes the process at step 17 once the validation model meets or exceeds the predetermined performance thresholds.

In the various embodiments, the computer-based systems, devices, methods, and instructions capture images of the document in one or more of color, black-and-white, ultraviolet, and infrared spectra, at the outset.

From the scans (through optical character recognition or other computer vision techniques) or from another source (such as the RFID on the document), determine characteristic features such as: Content, which may include the type of document, the issuer of the document, its issuing date, and its expiration date; Characteristics, which may include items such as the length and format of each element of content (e.g., the document ID number is 10 characters and only numeric); and/or Layout, which may include the positioning of content on the document.

From the environment, the embodiments determine characteristic features such as: Metrics on the available data used to train the model (e.g., quality and quantity, in total and by type); The past performance of the models (e.g., accuracy, throughput); The desired KPIs of the application (e.g., accuracy, throughput).

The modules 116, including algorithm orchestrator modules, execute, in parallel, ML algorithms to compare the document to other documents with shared features and those with different features to determine whether it is anomalous. Preferably, it will compare favorably to other documents of its type, issuer, and with overlapping periods of validity. It may compare favorably to other documents of its type, issuer, and with differing periods of validity if the features of the document did not change substantially. It will not compare favorably to other documents of its type with other issuers. It will not compare favorably to other documents of other types.

The results should then be: evaluated, by a human or another algorithm, against the desired KPIs, and fed back into the system to characterize the operational readiness and performance of the process; If non-anomalous, used to reinforce the existing model; If anomalous, used to create a new model (e.g., a new document type or version has been detected, or a fraudulent example has been detected).

The system monitors the outcomes for each issuer, type, and validity period and, when enough accuracy has been obtained, indicate that the particular model can be used operationally.

The model should then be produced with a lineage and version that can be controlled, then saved in a form that permits integration with an image processing workflow.

Accordingly, this disclosure provides systems, devices, methods, and instructions for generating unsupervised models for classifying and validating travel documents, including receiving a set of travel document data, processing the travel document data using an unsupervised learning algorithm to generate a classification model, evaluating the classification model using predetermined evaluation metrics, and storing the evaluated classification model in a model repository.

It will be apparent to those skilled in the art that various modifications and variations can be made in the embodiments of the present invention without departing from the spirit or scope of the invention. Thus, it is intended that the present invention cover the modifications and variations of this invention provided they come within the scope of the appended claims and their equivalents.

1. A method for generating unsupervised models for classifying and validating travel documents, comprising:
receiving a set of travel document data;
processing the travel document data using an unsupervised learning algorithm to generate a classification model;
evaluating the classification model using predetermined evaluation metrics; and
storing the evaluated classification model in a model repository.

2. The method of claim 1, wherein the unsupervised learning algorithm comprises a clustering algorithm.

3. The method of claim 1, further comprising:
adapting the classification model in response to new travel document data.

4. The method of claim 1, further comprising:
detecting that a quantity of travel document data for a specific document type is below a predetermined threshold; and
generating synthetic travel document data by applying controlled variations to existing travel document data of the specific document type, wherein the synthetic travel document data is used to augment the set of travel document data processed by the unsupervised learning algorithm.

5. The method of claim 1, wherein the travel document data comprises multi-spectral images including color, black-and-white, ultraviolet, and infrared images.

6. The method of claim 5, wherein the travel document data further comprises at least one of RFID chip data or optical character recognition (OCR) extracted data.

7. The method of claim 1, wherein processing the travel document data comprises:
extracting features from the travel document data, wherein the extracted features include at least one of extracted sub-images, text, security markings, layout characteristics, or color patterns.

8. A non-transitory computer-readable medium storing instructions that, when executed by a processor, cause the processor to generate unsupervised models for classifying and validating travel documents, the computer-readable medium having instructions for:
receiving a set of travel document data;
processing the travel document data using an unsupervised learning algorithm to generate a classification model;
evaluating the classification model using predetermined evaluation metrics; and
storing the evaluated classification model in a model repository.

9. The computer-readable medium of claim 8, wherein the unsupervised learning algorithm comprises a clustering algorithm.

10. The computer-readable medium of claim 8, further comprising instructions for:
adapting the classification model in response to new travel document data.

11. The computer-readable medium of claim 8, further comprising instructions for:
detecting that a quantity of travel document data for a specific document type is below a predetermined threshold; and
generating synthetic travel document data by applying controlled variations to existing travel document data of the specific document type, wherein the synthetic travel document data is used to augment the set of travel document data processed by the unsupervised learning algorithm.

12. The computer-readable medium of claim 8, wherein the travel document data comprises multi-spectral images including color, black-and-white, ultraviolet, and infrared images.

13. The computer-readable medium of claim 8, wherein the travel document data further comprises at least one of RFID chip data or optical character recognition (OCR) extracted data.

14. The computer-readable medium of claim 8, wherein processing the travel document data comprises instructions for:
extracting features from the travel document data, wherein the extracted features include at least one of extracted sub-images, text, security markings, layout characteristics, or color patterns.

15. A system for evaluating travel document classification models, comprising:
a data input module configured to receive travel document data;
a model processing module configured to apply an unsupervised learning
algorithm to the travel document data to generate a classification model;
an evaluation module configured to apply evaluation metrics to the classification model; and
a storage module configured to store the evaluated classification model.
